(19) United States
(12) Patent Application Publication
(10) Pub. No.: US 2011/0119250 A1
(43) Pub. Date: May 19, 2011

(54) Forward Progress Search Platform

(75) Inventor: Randy W. Lacasse, Fairfax Station, VA (US)

(73) Assignee: CPA GLOBAL PATENT RESEARCH LIMITED

(21) Appl. No.: 12/619,223

(22) Filed: Nov. 16, 2009

(51) Int. Cl. G06F 17/30; G06F 3/048

(52) U.S. Cl. 707/717; 715/781; 715/843; 715/833; 715/853; 715/840; 707/769; 707/E17.017

(57) ABSTRACT

Methods, systems, and mediums for providing search functionality. A user interface can include a plurality of input elements. Various searches can be executed based on inputs to the input elements. A result set of documents and a search history can be displayed simultaneously. The search history can be displayed via the plurality of input elements. This can facilitate efficient perusal of search results and efficient modification of a search strategy. Accordingly, a user can quickly and efficiently review and analyze the results of a search. Additionally, the user can quickly and efficiently modify the search strategy to obtain new or refined results if determined that the original results are not as desired.

### FIELD OF THE DISCLOSURE

This generally relates to techniques for providing search capabilities and conducting searches via a search platform.

### BACKGROUND

Patent applications submitted for examination before the U.S. Patent and Trademark Office must meet certain requirements in order to issue as patents. For example, the subject matter claimed in the patent applications must be deemed new, useful, and non-obvious. Similar standards are applied in patent offices of most, if not all, foreign patent offices. To more effectively prepare a patent application for examination, it is useful to have knowledge of prior art, including prior patent documents (e.g., patents and published patent applications) in related areas of technology since only one patent may be granted per invention. Conducting a patent search can be one way in which prior art can be ascertained. The results of the patent search can help the drafter of a patent application to focus on aspects that appear to be patentable subject matter and aid in developing a reasonable strategy for achieving the goals of the inventor or owner of the patent rights.

Prior to the evolution of technology in the current electronic information age, patent searches were conducted manually. A searcher would review a patent disclosure and conduct a paper search based on a patent classification system. With the advent of information technology, paper search has given way to electronic search since most patents and published patent applications are available in electronic form. Unfortunately, although electronic search tools can provide search results much faster than a paper search, existing tools can impede efficiency by not facilitating efficient perusal of search results nor easy modification of a search strategy.

### SUMMARY

This relates to a search platform that can facilitate efficient perusal of search results and efficient modification of a search strategy. Accordingly, the search platform can enable a user to quickly and efficiently review and analyze the results of a search. Additionally, the search platform can enable the user to quickly and efficiently modify the search strategy to obtain new or refined results when it is determined that the original results are not as desired.

An example embodiment can be directed to a method for providing search functionality via a user interface. The method can involve displaying a plurality of input elements. Each input element can facilitate inputting an input. A first search can be executed based on a first input and a result set of documents corresponding to the first search can be displayed. A second search can be executed based on a second input and the first input. A result set of documents corresponding to the second search and a search history comprising the first input and the second input can be simultaneously displayed. Each of the first input and the second input can be removed or modified via the search history. The search history can be displayed via the plurality of input elements, independently of the input elements, or a combination of the two.

In an embodiment, the documents can be patent documents, such as issued patents, patent publications, and patent applications. Additionally, an input element of the plurality of input elements can include any of a number of graphical user interface elements, such as a text box, a drop-down list, a button, a radio button, a check box, a slider, a spinner, or a tree view. Also, the display of the search history or the result set can be selectively collapsible.

In a further embodiment, a third search can be executed based on a third input, the first input, and the second input. The search history can be updated to comprise the first input, the second input, and the third input, each of which can be selectively removed or modified via the search history. The search history and a result set of documents corresponding to the third search can be simultaneously displayed.

If the second input is removed, a fourth search can be executed based on the first input and the third input. The search history can be updated to comprise the first input and the third input, each of which can be selectively removed or modified via the search history. A result set of documents corresponding to the fourth search can be displayed simultaneously with the search history.

If the second input is modified rather than removed, a fourth search can be executed based on the first input, the modified second input, and the third input. The search history can be updated to comprise the first input, the modified second input, and the third input, each of which can be selectively removed or modified via the search history. A result set of documents corresponding to the fourth search can be displayed simultaneously with the search history.

In an embodiment, a search can be executed based on all currently-displayed or active inputs when any input is added, removed, or modified.

In another embodiment, the user interface can comprise a window. A result set of documents corresponding to a search can be displayed in a first section of the window. The plurality of input elements and the search history can be displayed in a second section of the window. In addition, a document from a result set of documents can be displayed in a third section of the window.

An additional embodiment can be directed to a search system that includes a processor and a display. The processor can execute a first search based on a first input and a second search based on a second input and the first input. The display can display a plurality of input elements each for inputting an input. The display can further display a result set of documents corresponding to the first search, a result set of documents corresponding to the second search, and a search history comprising the first input and the second input. The display can display the result set of documents corresponding to the second search and the search history simultaneously. Further, the search history can be configured to permit the removal or modification of the first input and the second input.

In an embodiment, a computer-readable medium can store instructions to be executed by a computer. The instructions can include displaying a plurality of input elements each for inputting an input. The instructions can further include executing a first search based on a first input and displaying a result set of documents corresponding to the first search, and executing a second search based on a second input and the first input. The instructions can cause the computer to simultaneously display a result set of documents corresponding to the second search and a search history comprising the first input and the second input. The first input and the second input can be selectively removed or modified via the search history.

Another embodiment can include a system for providing search functionality. The system can include means for displaying a plurality of input elements, each input element for inputting an input. The system can further include means for executing a first search based on a first input and means for displaying a result set of documents corresponding to the first search. Additionally, the system can include means for executing a second search based on a second input and the first input, and means for simultaneously displaying a result set of documents corresponding to the second search and a search history comprising the first input and the second input. Each of the first input and the second input can be removed or modified via the search history.

### BRIEF DESCRIPTION OF THE DRAWINGS

FIG. 1 illustrates an example of search platform architecture.

FIG. 2 illustrates an example of a process for conducting multiple searches.

FIG. 3 illustrates an example of a process for searching a patent collection.

FIG. 4 illustrates an example of a user interface.

FIG. 5 illustrates an example of a computing device.

### DETAILED DESCRIPTION

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

This relates to a search platform that can facilitate efficient perusal of search results and efficient modification of a search strategy. Accordingly, the search platform can enable a user to quickly and efficiently review and analyze the results of a search. Additionally, the search platform can enable the user to quickly and efficiently modify the search strategy to obtain new or refined results when it is determined that the original results are not as desired.

Although the exemplary embodiments are discussed with respect to a collection of patent documents, the search platform described can be applied to any collection of documents.

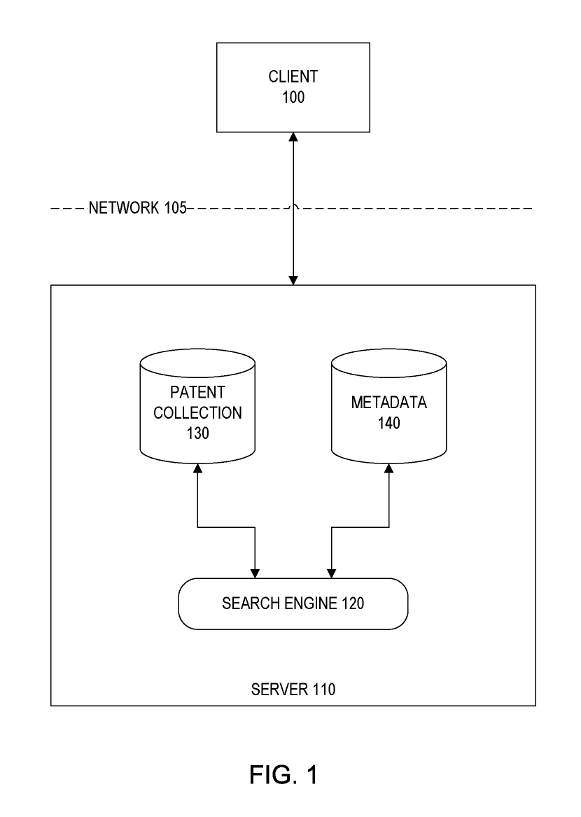

FIG. 1 illustrates an embodiment of exemplary search platform architecture. In the illustrated embodiment, client 100 can access server 110 across network 105. Server 110 can deploy search engine 120, which can be associated with patent collection 130 and metadata 140.

Patent collection 130 can include one or more databases storing patent documents, such as patents and/or patent publications for example, associated with one or more national patent offices. Metadata 140 can include one or more databases storing data associated with the patent documents. The data can include bibliographic information, document vectors, classification information, summaries or abstracts, etc., related to the documents in the collection. The data can be organized in an index including a record for each document.

Although patent collection 130 and metadata 140 are shown as distinct databases in the embodiment illustrated in FIG. 1, in other embodiments the data embodied in patent collection 130 and metadata 140 can be stored together in one or more databases or other suitable storage medium.

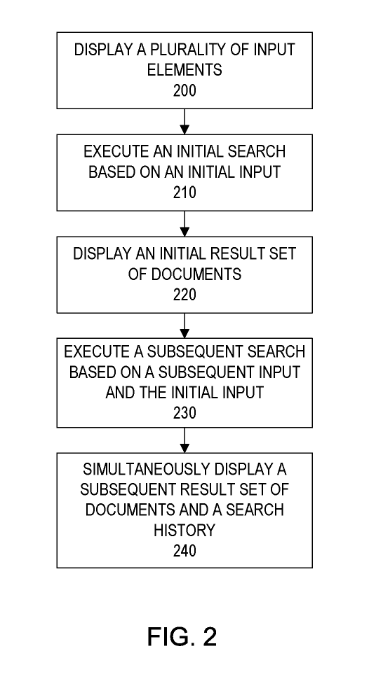

FIG. 2 illustrates an exemplary embodiment for conducting multiple searches.

A plurality of input elements can be displayed (block 200). The input elements may be used to enter input to be used in conducting a search of patent collection 130, for example. The input elements can include various graphical user interface (“GUI”) input elements, such as a text box, a drop-down list, a button, a radio button, a check box, a slider, a spinner, and/or a tree view. An input element can, in some cases, include a combination of elements, such as a combination of two text boxes for entering a range.

An initial search can be executed (block 210) based on an input entered via one of the input elements. Alternatively, an initial search can be executed based on a combination of inputs entered via multiple input elements. A search query can be formed based on the input(s).

Various techniques for forming a search query can be implemented. For example, in an embodiment, all inputs can be combined to create a single search query string. Such an embodiment may include appending certain identifiers to the various inputs in the string to indicate a category and/or relative importance of each input. In another embodiment or in the same embodiment, some of the inputs can be processed separately to limit which documents in the patent collection 130 are ultimately searched, for example, by document vector comparison. Such separately-processed inputs may not be included in a query document vector. Thus, for example, if a user specifies that only English documents are to be searched, such a specification could be used to limit which documents from patent collection 130 are ultimately searched. There are many techniques for forming and processing search queries based on inputs that are well-known to persons having ordinary skill in the art. Such techniques are included within the scope of this disclosure.

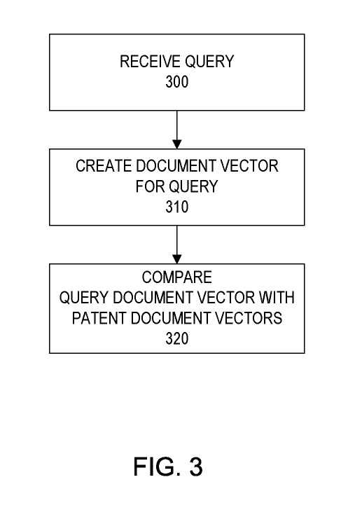

The search can be executed by search engine 120 over patent collection 130. The ways in which search engine 120 can search a document collection can be myriad. FIG. 3 illustrates an embodiment in which search engine 120 can employ a vector based search methodology.

In using a vector based search methodology as illustrated in the embodiment of FIG. 3, upon receiving a query (block 300) search engine 120 can create (block 310) a document vector for the query. For example, the document vector can be a weighted list of words and phrases, such as:

[table, 1][chair, 0.5][plate, 0.2]

as a simplified example. Once the query document vector is created, search engine 120 can compare (block 320) the query document vector with document vectors retrieved from patent collection 130 that have been previously created for each of the patent documents in patent collection 130. The document vectors can also be stored in metadata 140, such as in a record in the index corresponding to each document in patent collection 130. The comparison can include, for example, multiplying the weights of any common terms among the query document vector and the retrieved document vector, and adding the results to obtain a similarity ranking. Taking another simplified example:

query document vector: [table, 1][chair, 0.5][plate, 0.2]

retrieved document vector: [cup, 1][saucer, 0.7][chair, 0.6][plate, 0.5]

similarity=0.5*0.6+0.2*0.5=0.4

If the similarity ranking exceeds a predefined threshold, search engine 120 can consider the patent document associated with the retrieved document vector to be a match. In other embodiments, rather than using a vector based search methodology, search engine 120 can utilize less dynamic search methodologies that do not involve the creation of document vectors for the patent documents.

In the vector based search methodology described above, each patent document stored in patent collection 130 can be associated with one or more document vectors. For example, since patent documents such as patents and patent publications usually have a defined number of sections for meeting statutory filing requirements, a distinct document vector can be created for various sections or combinations of sections of a patent document, enabling search engine 120 to tailor a search on specific sections of the patent document. Further, the document vectors can be adjusted to remove non-relevant words or phrases to yield a smaller and more concise document vector, which can improve efficiency of query processing due to time not spent by search engine 120 to process the removed strings.

After execution of the query, one or more documents can be identified as relevant to the input and can be returned as a set of relevant documents. This set of documents can be displayed (block 220) on a display of client 100, for example. The result set can also be empty if no documents are deemed relevant to the search query.

Another input (or combination of inputs) may be entered via the input elements. A subsequent search may be executed (block 230) based on this new input(s) as well as the initial input(s) as the search query. A new set of relevant documents may be identified. This new set of documents can be displayed (block 240) on the display of client 100 simultaneously with a search history. The search history can include the initial input(s) and the subsequent input(s). In an embodiment, the search history can be displayed via the input elements, all of which can be displayed on the current page. The input elements can reflect the currently-active input to each input element and can be displayed simultaneously with the current, or most recent, set of relevant documents. Thus, a user may easily see the effect of a combination of inputs on the search results. In such an embodiment, the search history can comprise the currently-active inputs, that is, all inputs that were most recently submitted to search engine 130 as a search. In this example, the input elements would reflect the initial input(s) and the subsequent input(s).

In an embodiment, in addition to or instead of displaying the search history via the input elements, a search history comprising a list of executed searches can be displayed showing combinations of inputs previously searched. The search history could also show a number of documents returned in the result set for each combination of inputs. The search history can be displayed simultaneously with the input elements and the current result set. Additionally, the search history can be configured such that if a user clicks on a particular search in the search history, that combination of inputs can be populated into the input elements. In an embodiment, the search based on those inputs can be automatically executed again and the result set of documents identified and displayed. Alternatively, the user can alter the inputs from the previous search and/or add new inputs, and then click on a search button to execute a search.

A user may conduct subsequent searches by entering new inputs into other input elements, modifying currently-active inputs, or removing currently-active inputs to further influence the result set of documents. After entry, modification, or removal of an input, a search can be immediately executed. The search can be executed based on just the currently-active inputs. Thus, in an embodiment, if a currently-active input is removed, that input will not be included in a search query. However, currently-active inputs that have not been changed can be included in the search query along with new inputs and/or modified inputs.

A new search can be executed immediately upon entry, removal, or modification of an input. Alternatively, multiple inputs can be entered and/or changed and a search can be conducted only after pressing a search button, for instance. A hybrid approach could also be used, such as immediately executing a search upon modification of only certain input elements.

In an embodiment, modification of a search query may involve only refining the search to search within a current result set. For example, a user may decide to exclude documents within the current result that have a certain characteristic. In such a case, the refining of the result set may be accomplished at client 100, rather than connecting to server 110 to have the search engine 120 perform the modified search and/or refine the result set. The client may be able to accomplish the refinement using metadata obtained from the search engine associated with the original result set for example.

The search history can be updated upon execution of each new search. In an embodiment, if the search history is displayed via the input elements, prior to executing a search the search history may be altered on the display as a user modifies the input elements, but the search history can still be stored such that a user can recall the previous inputs if desired.

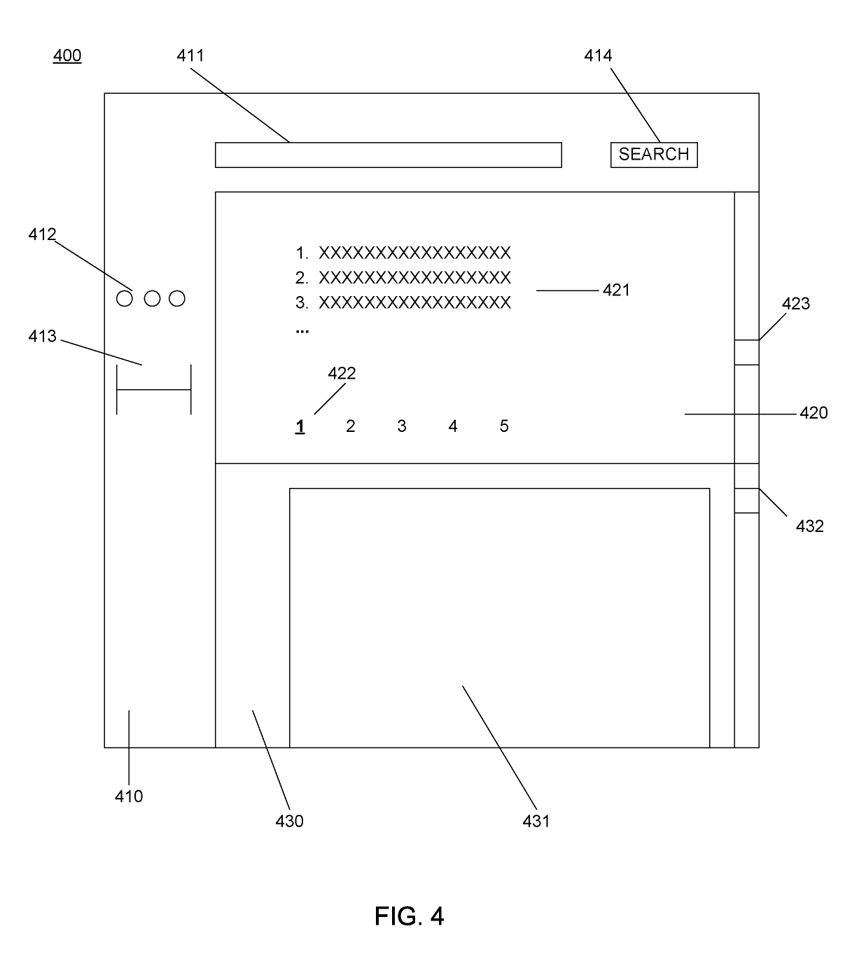

FIG. 4 illustrates an exemplary embodiment of a user interface that can be associated with and/or displayed on client 100. In the illustrated embodiment, the user interface can comprise a window 400.

An input section 410 can provide various GUI input elements, or navigators, that can be used to provide input to the search engine. For instance, input section 410 can include a text box 411 for entering search terms, radio buttons 412 for selecting or deselecting a document characteristic for example, and a slider 413 for specifying a value or range. These various navigators can be used to specify and refine a search to be conducted on patent collection 130. Many other GUI input elements can be provided, as discussed previously.

The search history can be displayed via the navigators. The navigators thus can represent an analysis of a result set displayed in result section 420 because a user can readily perceive the specifics of a search query that resulted in the result set. Further towards this analysis functionality, inputs to the navigators can be added, modified, and/or removed on the fly with instantaneous reflection in the search results. Thus, real-time comparison and verification of the soundness of a particular search strategy (combination of inputs) can be achieved. In an embodiment, if the search history comprises a list of executed searches, such a list can also be displayed in the input section 410.

A search button 414 can also be provided in input section 410 for requesting that a search be performed based on current inputs to the navigators. In an embodiment, a search can be automatically performed upon entry of an input into a navigator. Such a technique can be useful, for example, if a user is refining a search and desires to immediately see how search results are impacted based on each modification to each navigator.

After execution of a search, a result set can be provided to client 100. The result set can be presented in result section 420 of window 400.

Result section 420 can display document references of documents in the result set. The document references can be displayed as a list 421 and can include relevant text of the document underneath the reference to enable a user to further ascertain the content of the document. Slider 423 can be used to scroll through the current page if all of the document references can not be displayed within the portion of the page that is visible in result section 420. Depending on the size of a result set, additional pages of document references can be displayed on subsequent pages of result section 420 as indicated by buttons 422. A desired page can be selected via the buttons 422. In this example, there are five pages, as indicated by the five buttons.

A document reference can be a link. The document reference can link to a copy of the document stored in patent collection 130 of server 110. The document reference can also link to a copy of the document stored elsewhere in the world, such as a server of a patent office or a server local to client 100.

Additionally, the document reference can link to a copy of the document stored on a local memory of client 100. In such an embodiment, a copy of the document can be transmitted to the client along with the result set. Thus, the document can be immediately available to a user upon viewing the result set. The time and processing power often required to reconnect to a server to retrieve a document specified in a result set can thus be eliminated.

A document reference can be selected for viewing in the document view section 430. Document view section 430 can present a view 431 of a selected document from the result set. In one embodiment, as a default, the first document reference in the result set can be automatically selected, such that the document is automatically displayed in the document view section 430.

Slider 432 can be used to scroll through the view of a selected document. In an embodiment, the entirety of a single page of a document may not be visible in the document view section 430, and the slider can be used to scroll through the page. A button can be provided in document view section 430 to navigate through multiple pages of a multi-page document. In another embodiment, the entire document can be scrolled through using slider 432.

Many additional features can be provided in document view section 430 for facilitating efficient navigation, viewing, and processing of a document. For example, a print button may be provided for easily permitting a user to cause a selected document to be printed. In addition, an email button can be provided to email the document, a save button may be provided to save the document, and/or a PDF button may be provided to convert the document to portable document format, which can then be saved or emailed.

In an embodiment, a document can be selected for viewing in a separate screen. The selection can be made in the result section or in the document view section, such as by double-clicking on a document reference in list 421 or on a view 431 of the document. The separate screen could be a tabbed screen within window 400. The separate screen could also be a screen in a separate window from window 400. Accordingly, a larger view of a document can be obtained/presented without replacing the data in sections 410, 420, and 430. Presenting a view of a document in this manner can be beneficial by eliminating backtracking after viewing the document. In an embodiment using a network, backtracking often involves further communication with a server requesting data previously displayed or re-sending a search query. Backtracking can be time- and processor-intensive.

Input section 410, result section 420, and document view section 430 can be independent and distinct. Each section can be displayed to the user independently of the other sections. Also, each section can retain its data independently of the other sections. As a result, the view of one section can remain unchanged even though another section is being manipulated. Thus, slider 423 can be used to scroll through a current page of result section 420, yet the view of query section 410 and document view section 430 can remain unchanged. Likewise, a different page of result section 420 can be selected via buttons 422 and the other sections can remain unchanged. The same can apply to modifications and manipulations within document view section 430.

However, changes within one section can be preferably reflected in different sections. For example, if a different document reference is selected in result section 420, the document indicated by that reference would preferably be displayed in view 431 of document view section 430. Thus, a previously displayed document could be replaced. Similarly, a modification of a search query in query section 410 would likely return a different result set. Preferably, result section 420 would display the new result set and document view section 430 would display a view of a selected document within the new result set.

As described above, the user interface can be an atomic search interface that provides a user with relevant information and functionality through a single window. The input elements, search results, and document previews can be seen and manipulated together. Thus, viewing a particular document indicated by the search results, for instance, does not necessarily require even a temporary obscuring of the input elements, which can display the most recent inputs, or the search results. Further, manipulation of the input elements can be reflected instantaneously in the search results. Accordingly, a user can more efficiently conduct searches, especially when the user does not have a definite search strategy and is experimenting with search inputs.

In an embodiment, one or more sections of the user interface can be selectively collapsed, yet remain active within window 400. In this way, non-collapsed sections can have more room for display to a user. For instance, a user may collapse the input section 410 after obtaining a satisfactory result set so that he/she may focus on reviewing the result set and previewing individual documents indicated therein. To facilitate collapsing of the sections, for example, a GUI element can be provided in association with each section, such as a displayed rotating “Q” to signify “query” for the input section 410.

In an embodiment, the layout of the user interface can differ from that depicted in FIG. 4 and described above. The layout within a single screen can vary widely, for example, depending on the number of navigators or other features in the various sections, the preferences of a system designer, and/or the preferences of a user. In addition, query section 410, result section 420, and document view section 430 do not have to be displayed as portions of a single screen. For example, the sections can be displayed in separate tabbed screens or in separate windows. Alternatively, there can be a different arrangement and/or number of sections, such as displaying the search history in its own section.

In an embodiment, an initial screen presented to a user may not include a result section 420 and document view section 430. Thus, an initial screen can include simply a query section 410.

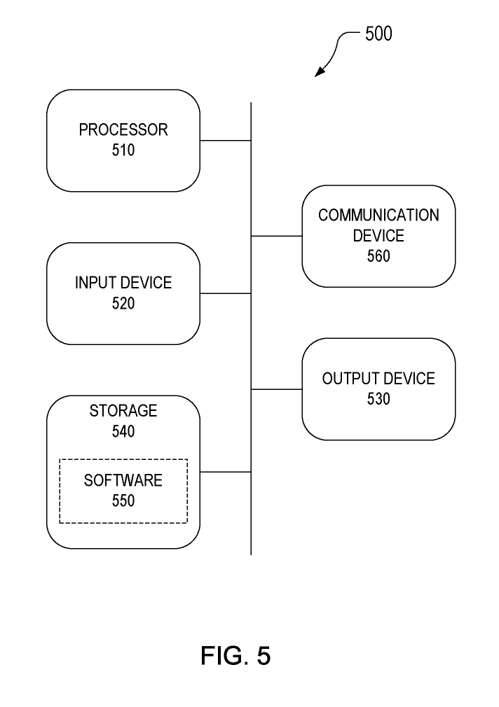

FIG. 5 shows a block diagram of an example of a computing device, which may generally correspond to client 100 and server 110. The form of computing device 500 may be widely varied. For example, computing device 500 can be a personal computer, workstation, server, handheld computing device, or any other suitable type of microprocessor-based device. Computing device 500 can include, for example, one or more components including processor 510, input device 520, output device 530, storage 540, and communication device 560. These components may be widely varied, and can be connected to each other in any suitable manner, such as via a physical bus, network line or wirelessly for example.

For example, input device 520 may include a keyboard, mouse, touch screen or monitor, voice-recognition device, or any other suitable device that provides input. Output device 530 may include, for example, a monitor or other display, printer, disk drive, speakers, or any other suitable device that provides output.

Storage 540 may include volatile and/or nonvolatile data storage, such as one or more electrical, magnetic or optical memories such as a RAM, cache, hard drive, CD-ROM drive, tape drive or removable storage disk for example. Communication device 560 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 550 can be stored in storage 540 and executed by processor 510, and may include, for example, programming that embodies the functionality described in the various embodiments of the present disclosure. The programming may take any suitable form. For example, in one embodiment, programming embodying the patent collection search functionality of search engine 120 can be based on an enterprise search platform, such as the Fast Enterprise Search Platform by Microsoft Corp. for example.

Software 550 can also be stored and/or transported within any computer-readable storage medium for use by or in connection with an instruction execution system, apparatus, or device, such as computing device 500 for example, that can fetch instructions associated with the software from the instruction execution system, apparatus, or device and execute the instructions. In the context of this document, a computer-readable storage medium can be any medium, such as storage 540 for example, that can contain or store programming for use by or in connection with an instruction execution system, apparatus, or device.

Software 550 can also be propagated within any transport medium for use by or in connection with an instruction execution system, apparatus, or device, such as computing device 500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method for providing search functionality via a user interface, comprising:
displaying a plurality of input elements each for inputting an input;
executing a first search based on a first input and displaying a result set of documents corresponding to the first search;
executing a second search based on a second input and the first input; and
simultaneously displaying a result set of documents corresponding to the second search and a search history comprising the first input and the second input, wherein each of the first input and the second input can be removed or modified via the search history.

2. A method according to claim 1, wherein the search history is displayed via the plurality of input elements.

3. A method according to claim 1, further comprising:
executing a third search based on a third input, the first input, and the second input;
updating the search history to comprise the first input, the second input, and the third input, each of which can be removed or modified via the search history; and
simultaneously displaying the search history and a result set of documents corresponding to the third search.

4. A method according to claim 3, wherein if the second input is removed,
a fourth search is executed based on the first input and the third input,
the search history is updated to comprise the first input and the third input, each of which can be removed or modified via the search history, and
a result set of documents corresponding to the fourth search is displayed simultaneously with the search history.

5. A method according to claim 3, wherein if the second input is modified,
a fourth search is executed based on the first input, the modified second input, and the third input,
the search history is updated to comprise the first input, the modified second input, and the third input, each of which can be removed or modified via the search history, and
a result set of documents corresponding to the fourth search is displayed simultaneously with the search history.

6. A method according to claim 1, wherein the user interface comprises a window, the result set of documents corresponding to the second search is displayed in a first section of the window, and the plurality of input elements and the search history are displayed in a second section of the window.

7. A method according to claim 6, further comprising displaying a document from the result set of documents corresponding to the second search in a third section of the window.

8. A method according to claim 7, wherein the document is a patent document.

9. A method according to claim 1, wherein an input element of the plurality of input elements comprises a text box, a drop-down list, a button, a radio button, a check box, a slider, a spinner, or a tree view.

10. A method according to claim 1, wherein the display of the search history or the result set is selectively collapsible.

11. A search system comprising:
a processor configured to execute a first search based on a first input and a second search based on a second input and the first input; and
a display configured to display a plurality of input elements each for inputting an input, a result set of documents corresponding to the first search, a result set of documents corresponding to the second search, and a search history comprising the first input and the second input,
wherein the display is configured to display the result set of documents corresponding to the second search and the search history simultaneously, and
wherein the search history is configured to permit the removal or modification of the first input and the second input.

12. A search system according to claim 11, wherein the display is configured to display the search history via the plurality of input elements.

13. A search system according to claim 11, wherein:
the processor is further configured to execute a third search based on a third input, the first input, and the second input, and
the display is further configured to simultaneously display the search history updated to comprise the first input, the second input, and the third input, each of which can be removed or modified via the search history, and a result set of documents corresponding to the third search.

14. A search system according to claim 13, wherein:
the processor is further configured to execute a fourth search based on the first input and the third input if the second input is removed, and
the display is further configured to simultaneously display the search history updated to comprise the first input and the third input, each of which can be removed or modified via the search history, and a result set of documents corresponding to the fourth search.

15. A search system according to claim 13, wherein:
the processor is further configured to execute a fourth search based on the first input, a modified second input, and the third input if the second input is modified, and
the display is further configured to simultaneously display the search history updated to comprise the first input, the modified second input, and the third input, each of which can be removed or modified via the search history, and a result set of documents corresponding to the fourth search.

16. A search system according to claim 11, wherein the display is further configured to display a user interface comprising a window, the second result set of relevant documents in a first section of the window, and the plurality of input elements and the search history in a second section of the window.

17. A search system according to claim 16, wherein the display is further configured to display a document of the result set of documents corresponding to the second search in a third section of the window.

18. A search system according to claim 17, wherein the document is a patent document.

19. A search system according to claim 11, wherein an input element of the plurality of input elements comprises a text box, a drop-down list, a button, a radio button, a check box, a slider, a spinner, or a tree view.

20. A search system according to claim 11, wherein the display is configured to selectively collapse the search history or the result set.

21. A computer-readable medium storing instructions to be executed by a computer, the stored instructions comprising:
displaying a plurality of input elements each for inputting an input;
executing a first search based on a first input and displaying a result set of documents corresponding to the first search;
executing a second search based on a second input and the first input; and
simultaneously displaying a result set of documents corresponding to the second search and a search history comprising the first input and the second input, wherein each of the first input and the second input can be removed or modified via the search history.

22. A computer-readable medium according to claim 21, the instructions further comprising:
executing a third search based on a third input, the first input, and the second input;
updating the search history to comprise the first input, the second input, and the third input, each of which can be removed or modified via the search history; and
simultaneously displaying the search history and a result set of documents corresponding to the third search.

23. A system for providing search functionality, comprising:
means for displaying a plurality of input elements each for inputting an input;
means for executing a first search based on a first input;
means for displaying a result set of documents corresponding to the first search;
means for executing a second search based on a second input and the first input; and
means for simultaneously displaying a result set of documents corresponding to the second search and a search history comprising the first input and the second input, wherein each of the first input and the second input can be removed or modified via the search history.

24. A system according to claim 23, further comprising:
means for executing a third search based on a third input, the first input, and the second input;
means for updating the search history to comprise the first input, the second input, and the third input, each of which can be removed or modified via the search history; and
means for simultaneously displaying the search history and a result set of documents corresponding to the third search.
